(19) United States
(12) Patent Application Publication
(10) Pub. No.: US 2007/0095372 A1
(43) Pub. Date: May 3, 2007

(54) Flushing unit

(76) Inventor: Bengt Fjallstrom, Tidaholm (SE)

Correspondence Address: HARNESS, DICKEY & PIERCE, P.L.C., P.O. BOX 8910, RESTON, VA, 20195, US

(21) Appl. No.: 11/262,515

(22) Filed: Oct. 31, 2005

(51) Int. Cl. B08B 3/00; B08B 9/00

(52) U.S. Cl. 134/110; 134/111; 134/166 R

(57) ABSTRACT

A unit for internal cleaning of tube/house applications comprising a tank (2) and a filter unit (20) to be used with a cleaning media in form of liquid or gas that are pressed through a tube/hose application, RECOGNISED by a pump unit (23) which is an integrated part of the filter unit (2) where the pump unit is forcing the cleaning media through the filter inserts in the filter unit (2) and further through the tube/hose application (17), that are the object to be cleaned, and from the object to the tank (2) which is working interactive with the filter unit (20) throughout an overpressure in the tank (2) forcing the cleaning media back to the filter unit (20) and filling up the same for the next cycle.

### FIELD OF THE INVENTION

Example embodiments of the invention are directed to a “flushing unit”.

### SUMMARY OF THE INVENTION

The invention is concerning a process for internal cleaning of tube and hose applications that can be performed in a machine. The process is built around a tank (2) and a filter unit comprising a filter house (2) with a pump function working interactive with each other. A flow of a cleaning media is obtained when the cleaning media is forced to pass through the filter inserts in the filter house (2) and thereby obtain the desired cleanness before passing through the object to be cleaned (17) before returned to the tank (2). When the cleaning media returns to tank (2) a return filter (28) separate oil products and impurity particles. The cleaning media is refilling the filter house (20) from the tank (2) throughout an overpressure in the tank (2), the overpressure is moderated by a pressure regulator (11′). In the process final stage the cleaning media that is left in the object to be cleaned (17) is evacuated to the tank (2) by compressed air supplied at the inlet (24) to the application (17).

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a flushing unit in accordance with an example embodiment of the present invention.

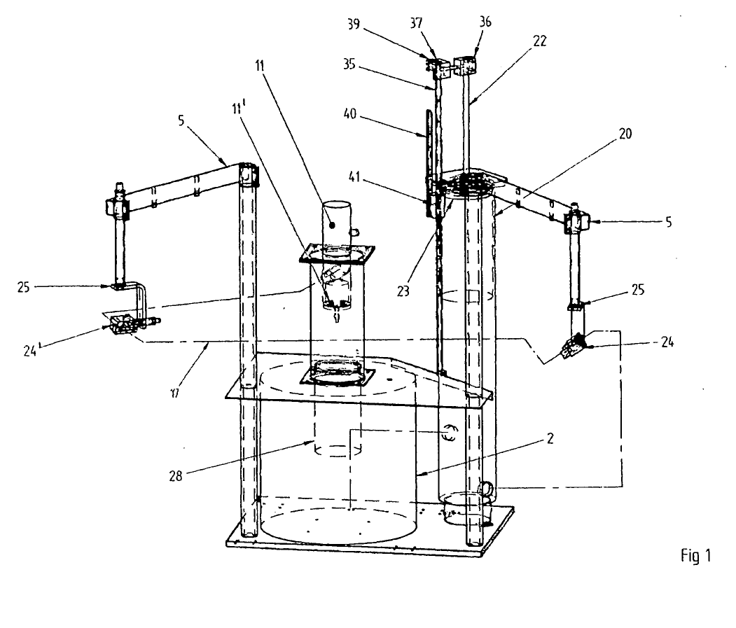

### DETAILED DESCRIPTION OF EXAMPLE EMBODIMENTS

The following description of example embodiment(s) is in no way intended to limit the invention, its application, or uses.

The invention is a “flushing unit” comprising a tank (2) on which movable organs (24) and (24′) is placed for connection of tube and hose applications on a movable connecting unit (25 on an arm (5).

A combined pump and filter unit (20) is placed in connection to the tank for distribution of a cleaning media to the object to be cleaned (17).

A flow of cleaning media is obtained by forcing it through the filter inserts in the filter unit (2) by means of a piston (23). The cleaned media continues through the object (17) and back to tank (2).

In the tank (2) impurities will be separated from the cleaning media by a return filter (28).

The piston (23) in the filter unit (20) is connected to a rod (22) which is connected to a unit (36) that is transferring the movement of the rod (22) to a movable guided holder (37) can glide along the rod (35).

The moveable unit (37) has a valve attached to it that is influenced by an adjustable rod (39) attached on the rod (35). When the movable unit (37) reach the top position it indicates the end of the cleaning cycle. A rod (41) is connected to a holder (4) which is attached so it can slide on the rod (35).

The rod (41) influences a valve on the holder (37) and is lockable sliding on the rod (35), the position indicates the length of the cleaning cycle.

The rod (35) comprise grows which influence a valve attached on the holder (37), during its movement along the rod (35) the valve passes over the grows and trigger thereby a function to intermittent force compressed air in to the cleaning media.

The cleaning media refill the filter unit (20) through the overpressure in tank, which is enables with help of compressed air that is admitted into the tank (2). The overpressure is caped on a desired level by a restrictor valve (11′) placed on the exhaust tube (11) on the tank (2).

The cleaning media left in the object (17) is blown back to the tank with compressed air, via a connection at the inlet to the moveable connecting unit (24).

The description of the invention is merely exemplary in nature and, thus, variations that do not depart from the gist of the invention are intended to be within the scope of the invention. Such variations are not to be regarded as a departure from the spirit and scope of the invention.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A unit for internal cleaning of tube/house applications comprising a tank (2) and a filter unit (20) to be used with a cleaning media in form of liquid or gas that are pressed through a tube/hose application, RECOGNISED by a pump unit (23) which is an integrated part of the filter unit (2) where the pump unit is forcing the cleaning media through the filter inserts in the filter unit (2) and further through the tube/hose application (17), that are the object to be cleaned, and from the object to the tank (2) which is working interactive with the filter unit (20) throughout an overpressure in the tank (2) forcing the cleaning media back to the filter unit (20) and filling up the same for the next cycle.

2. The filter unit (20) in claim 1, RECOGNISED by that the room in the filter unit is parted in such way that a part of the same can be used for a unit that is forcing the cleaning media through the filter inserts within the filter unit (20).

3. The tank (2) in claim 1, RECOGNISED by that the tank is supplied with an overpressure that is loading the filter unit (20) with cleaning media, whereby the overpressure is forcing the cleaning media from tank (2) to filter unit (20) to be set for the next cleaning cycle.
